(19) United States
(12) Patent Application Publication
(10) Pub. No.: US 2002/0144970 A1
(43) Pub. Date: Oct. 10, 2002

(54) Pendant controller for overhead lifting systems

(75) Inventor: Warren A. Seith, Bethlehem, PA (US)

Correspondence Address: MICHAEL BEST & FRIEDRICH LLP, 3773 CORPORATE PARKWAY, SUITE 360, CENTER VALLEY, PA, 18034-8217, US

(73) Assignee: Ingersoll-Rand Company

(21) Appl. No.: 09/828,336

(22) Filed: Apr. 6, 2001

(51) Int. Cl. B66C 13/44

(52) U.S. Cl. 212/285

(57) ABSTRACT

An electronic pendant controller and an overhead lifting system incorporating the same having a housing with at least one electrical control for controlling an input signal, an output signal, and combinations thereof between the pendant controller and a control device for the overhead lifting system. A first electronic interface is provided for conducting a signal between the pendant controller and an end effector attached to the pendant controller. Also provided is an electronic pendant controller and an overhead lifting system incorporating the same, having a housing with at least one electrical control for controlling a signal between the pendant controller and a control device for the overhead lifting system. At least one electrical controls is an analog, bi-directional proportional controller for changing direction and varying speed of the lifting system.

### BACKGROUND OF THE INVENTION

This invention generally relates to controllers for load-handling apparatus. More specifically, the invention relates to pendant controllers for overhead lifting systems capable of lifting, carrying, and automatically balancing loads of various weights.

Hoisting systems are generally electric hoist or pneumatic-hoist systems in which a load is lifted with a wire rope that is in line with the lifting device. Such systems are operated using various hand controls for changing lifting speed, which controls are manipulated by an operator. In the case of electric systems, these are electrically-driven hoists that have a hand control that controls a motor that raises or lowers a wire rope or chain typically with a hook attached to the end of the wire rope or chain. In the case of fluid operated hoists, these hand controls use a hand control that increases or decreases fluid pressure to the hoist to drive a ball screw that raises or lowers a load by a wire rope or chain.

Although hooks can be used at the ends of the wire ropes and chains attached to such lifting devices, to do any other function requires the use of other devices known as end effectors. Generally end-effectors are apparatus that is attached to the end of a lifting line to effect some action and can include vacuum lifting devices or jigs for lifting pallets, rolls of paper, etc. An example of a fluid-operated hoist of this type is the pneumatic lift shown and described in U.S. Pat. No. 4,708,574 issued Nov. 24, 1987 to Conboy et al. the disclosure of which is herein incorporated by reference.

In the event that these end effector devices require some controlled function, however, typically it was the case that a separate controlling device along with appropriate connecting cables was required. In the case of pneumatic devices, such lines would contain a pneumatic signal, while in electronic devices, an electronic signal would be used.

Recently, a microprocessor-controlled lifting device is available that provides for both flexibility of control and ease of operation. Available from Ingersoll-Rand Company as the INTELIFT lift assist device, this microprocessor-based lift assist device utilizes a microprocessor to control either a pneumatic or an electric hoisting device using a pendant controller that hangs from and is connected to the microprocessor-based controller. To date, however, the incorporation of end effectors into lifting systems using a micro-processor controlled lift device linked to a pendant controller required separate control lines to operate and control the end effector device.

The foregoing illustrates limitations known to exist in present pendant controller devices for hoisting systems. Thus it is apparent that it would be advantageous to provide an alternative directed to overcoming one or more of the limitations set forth above. Accordingly an alternative pendant controller is provided including the features more fully disclosed hereinafter.

### SUMMARY OF THE INVENTION

According to the present invention, an electronic pendant controller and an overhead lifting system incorporating the same is provided having a housing with at least one electrical control for controlling an input signal, an output signal, and combinations thereof between the pendant controller and a control device for the overhead lifting system. A first electronic interface is provided for conducting a signal between the pendant controller and an end effector attached to the pendant controller. Also provided is an electronic pendant controller and an overhead lifting system incorporating the same, having a housing with at least one electrical control for controlling a signal between the pendant controller and a control device for the overhead lifting system. At least one of the electrical controls is an analog, bi-directional proportional controller for changing direction and varying speed of the lifting system.

The foregoing and other aspects will become apparent from the following detailed description of the invention when considered in conjunction with accompanying drawing figures.

### BRIEF DESCRIPTION OF THE DRAWINGS

FIG. 1 is an elevational front view of a pendant controller according to an embodiment of the present invention;

FIG. 2 is an elevational side view of the pendant controller shown in FIG. 1;

FIG. 3 is an elevational rear view of the pendant controller shown in FIGS. 1 and 2 shown with an attachable mounting bracket;

FIG. 4 is a perspective view of an overhead hoist system according to one embodiment of the present invention;

FIG. 5 is a perspective view of an overhead hoist system according to an alternative embodiment of the present invention;

FIG. 6 is an elevational side view of a pendant controller according to an alternative embodiment of the present invention; and

FIG. 7 is a perspective view of the pendant controller in FIG. 6 with an attachable load cell.

### DETAILED DESCRIPTION OF THE PREFERRED EMBODIMENTS

The invention is best understood by reference to the accompanying drawings in which like reference numbers refer to like parts. It is emphasized that, according to common practice, the various dimensions of component parts as shown in the drawings are not to scale and have been enlarged for clarity.

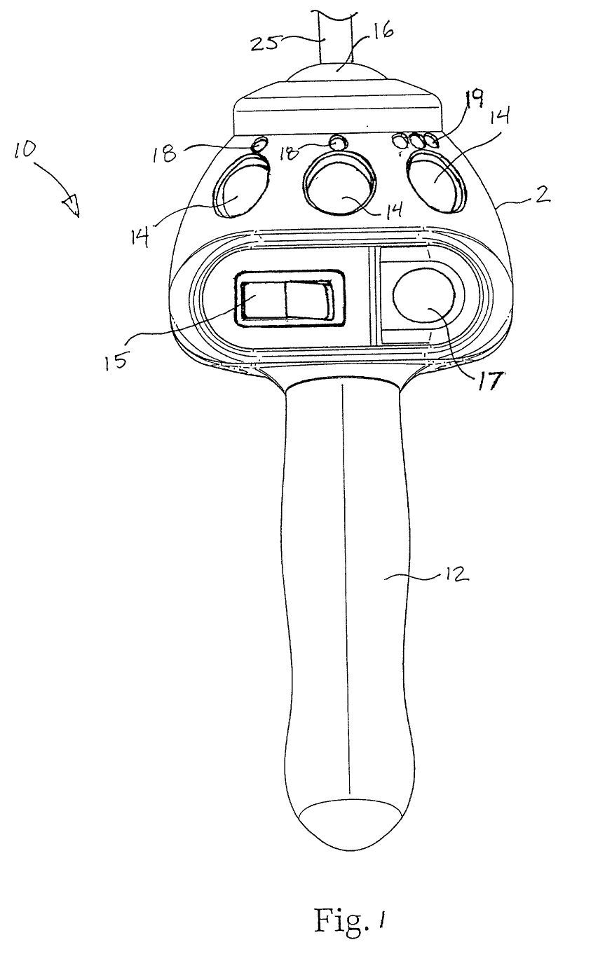

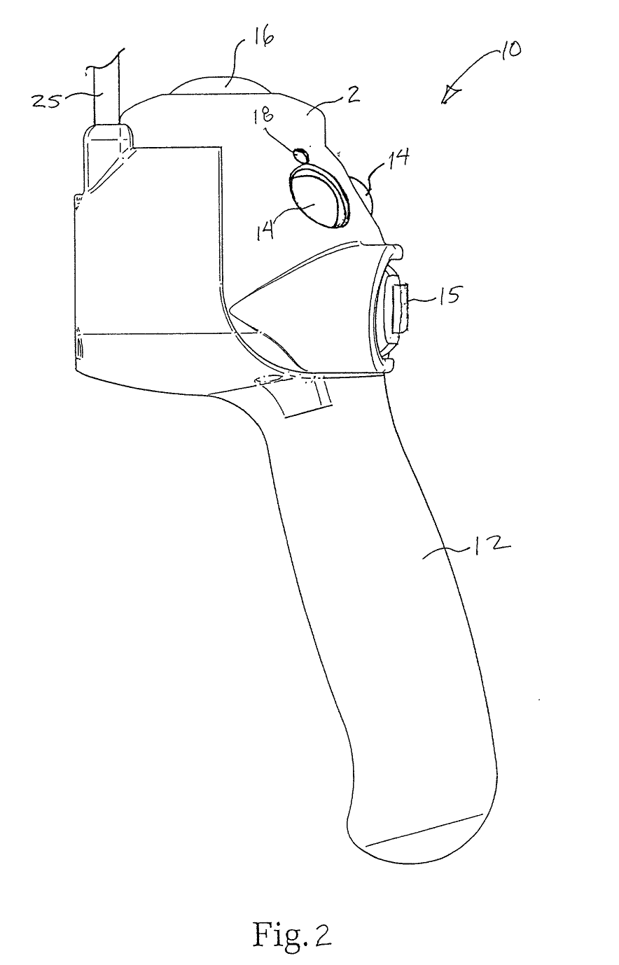

Referring now to the drawings, shown in FIGS. 1-5 is one embodiment of a hanging or pendant controller 10 according to the present invention having a housing 2 attached to a handle portion 12, preferably having a contoured grip surface. Disposed within and protruding out of housing 2 are various control buttons 14 and a separate stop button 16 that are switches connected to electronic control cable 25. Preferably, control cable 25 is an electrical cable capable of high speed digital communication and terminating in an appropriate connector 26 for attachment to a microprocessor-based controller 62, such as the INTELIFT control system available from Ingersoll-Rand Company.

Various input functions to the microprocessor-based controller such as power on/off and speed selection are preferably assigned to and operated by control buttons 14 while an emergency stop function is operated by and provided by stop button 16. A rocker switch 15, which is an analog, bi-directional proportional controller and known in the art, is also preferably included for controlling between an “up” (lifting) and “down” (lowering) state of operation. Preferably, indicator lights 18 are incorporated to indicate whether a particular function is on or off with individual or clusters of indicator lights 19 being used to indicate the magnitude of a variable parameter, such as speed, by lighting one or more lights to indicate low to high, respectively.

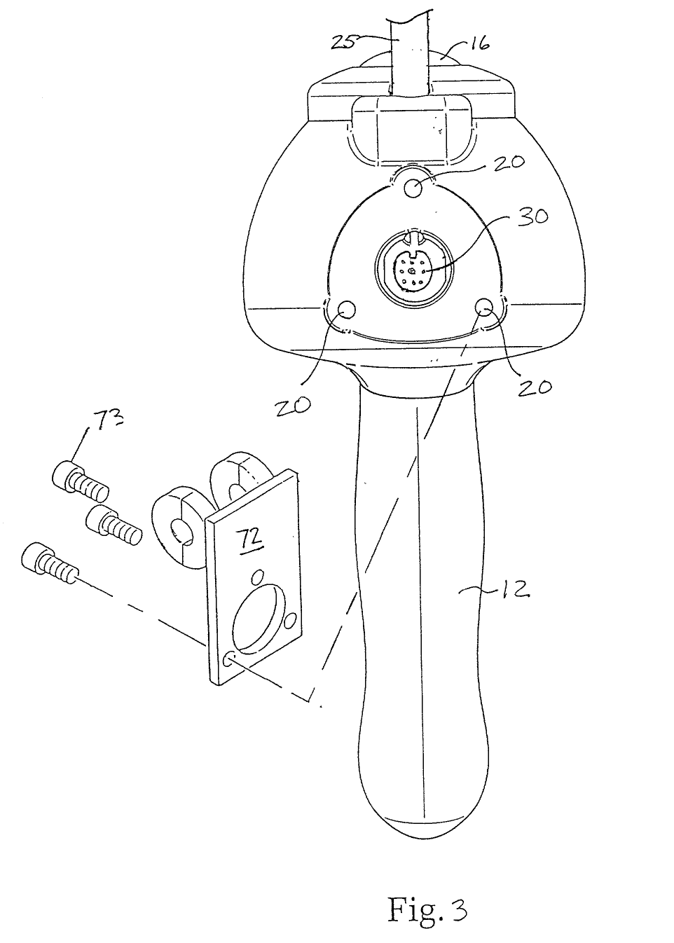

According to the present invention, shown in FIG. 3 on a rear surface of housing 2 is an electronic interface 30 that is connected either directly or through additional signal processing circuitry inside housing 2 to control cable 25 and, preferably, to an end effector control button 17 that switches on and off a particular operation to be performed by an end effector. Electronic interface 30 is, preferably, an electronic pin-type connector into which a microprocessor-based servo-device or other controlled device is attached for operation by a microprocessor control, to which cable 25 is attached. Preferably, mounting holes 20 are provided for attaching a mounting bracket 72 with screws 73. Mounting bracket 72 is then connected to a handling device end effector or other devices such as a load cell described in detail below.

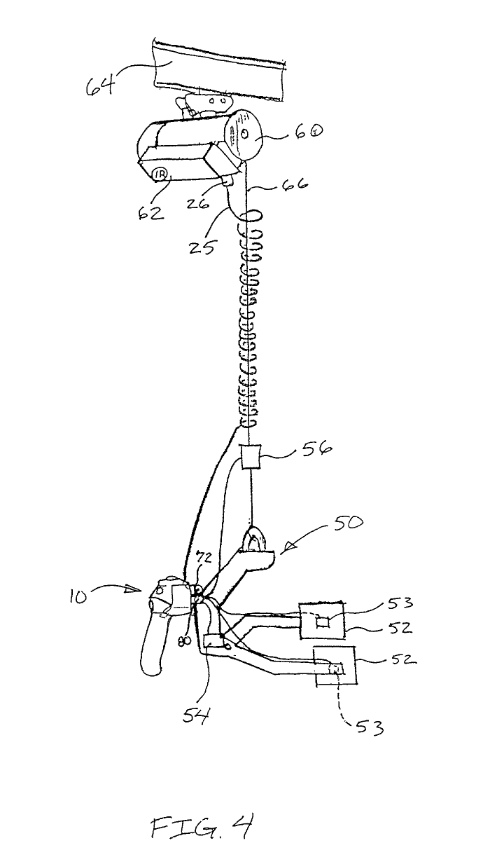

Shown in FIG. 4 is an hoisting system incorporating pendant controller 10 and having an overhead rail 64 attached to a hoist 60, which can be of the electric or fluid-driven type, attached via a wire rope or chain 66 to an exemplary end effector 50 having clamps 52 that are controlled by a servo control 54. Pendant controller 10 is attached to an end effector 50 via mounting bracket 72 in an “off-axis” configuration in which it is not in line with the lifting cable or chain. Sensors 53 and a load cell 56, which are known in the art and can be for example transducers, respectively provide electrical signals indicating the presence of an item to be lifted and of the weight of a load to be lifted. Input and output from sensors 53, load cell 56, and servo control 54 are individually connected to electronic interface 30 of pendant controller 10 via individual connecting wires that are joined to an effector signal plug 80. The input and output data is then fed from electronic interface 30 via control cable 25 to microprocessor-based controller 62 which appropriately reads and processes the input signals and transmits output control signals to the end effector. Preferably, end effector control button 17 is connected to provide manual switching control of the operation of end effector 50, for example, to operate a clamping/unclamping operation.

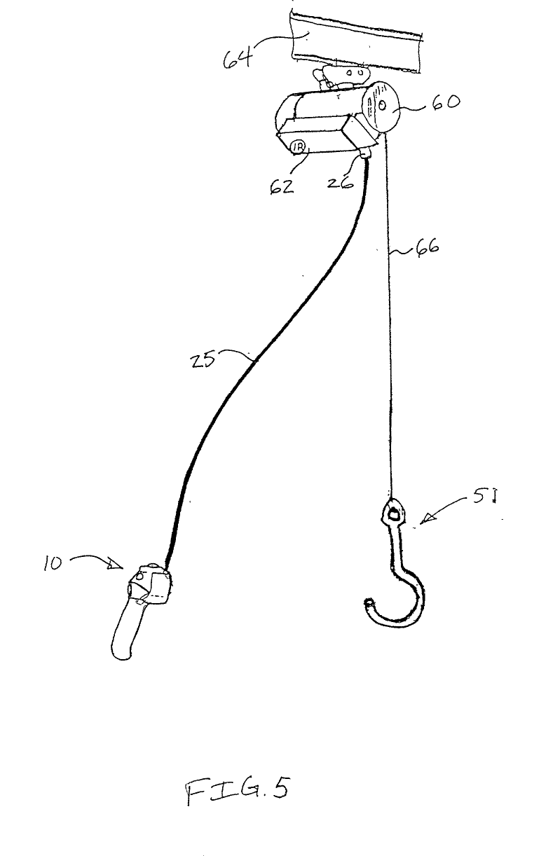

Shown in FIG. 5 is another “free-hanging” configuration in which the pendant controller 10 is not attached to an end effector 51 without having to be in line with the lifting cable or chain. This free-hanging configuration can be used with an end effector 51 that does not require any operating controls and can be a simple “J”-hook as shown. Operation of the pendant controller in this configuration is similar to that described above for the off-axis configuration except that, because no operational controls are needed from the microprocessor-based controller 62 to end effector 51, electronic interface 30 is not used and, optionally, may be eliminated from the pendant controller. In this manner, a free-hanging pendant is provided that can control lifting and moving operations from a location remote from the load to be lifted. Preferably, control cable 25 is supported by an internally or externally located wire cable.

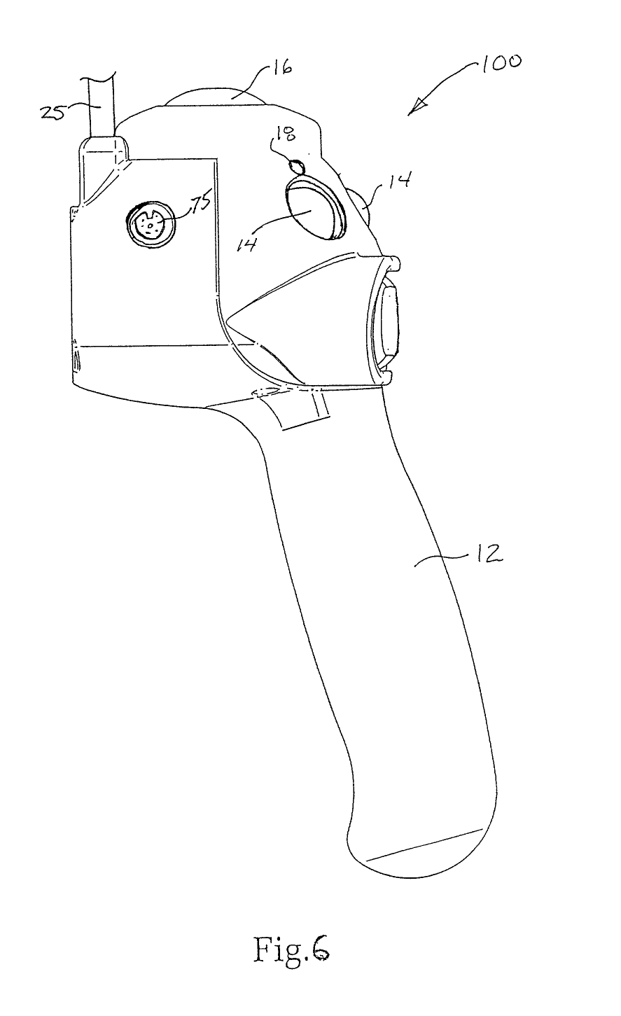

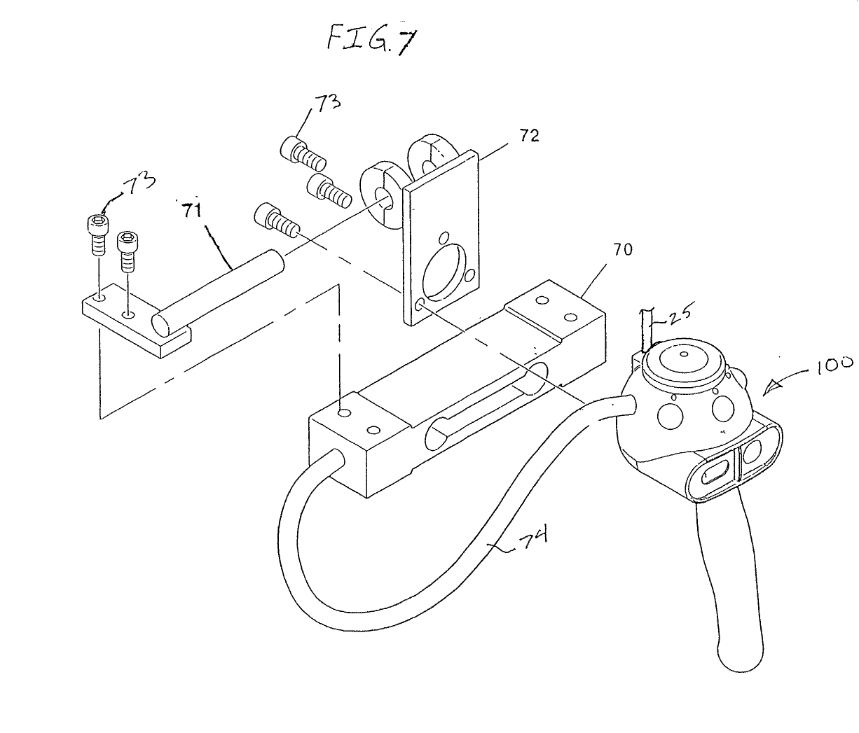

Although with respect to the embodiments above, controlling the direction and speed of lifting of the hoist is accomplished manually by analog rocker switch 15, in another embodiment shown in FIGS. 6 and 7 this controlling may be accomplished automatically using an additional load cell. Shown in FIGS. 6 and 7 is a pendant control 100 attached to load cell 70 (shown in FIG. 7) that can automatically measure whether an upward or downward force is being applied to the pendant controller. The load cell 70 provides an electric signal through pendant controller 100 to microprocessor-based controller 62 via load cell cable 74 connected to a load cell interface 75 that in turn is connected to control cable 25. Load cell 70 is typically a transducer as is known in the art and connected to pendant controller 100 via mounting bracket 72 and load cell bracket 71 that attach respectively to pendant controller 100 and load cell 70 using screws 73. Pendant controller 100 is similar to pendant controller 10 in its use and construction except that load cell interface 75 is added either externally, as shown, or internally and rocker switch 15 can be eliminated as its manual controlling function is replaced by the analog proportional signal that load cell 70 automatically provides.

Thus, according to a preferred embodiment of the present invention, by incorporating an electronic interface 30 in the housing of a pendant controller, various operating configurations can be achieved in which the pendant controller can be easily connected and disconnected to different types of end effectors near their point of connection to the wire rope or chain without having to run a separate cable up to the microprocessor-based controller 62. Moreover, in the case of end effectors that do not require any controls, according to another preferred embodiment, a free-hanging pendant is also provided that can control lifting and moving operations from a location remote from the load to be lifted.

While embodiments and applications of this invention have been shown and described, it will be apparent to those skilled in the art that many more modifications are possible without departing from the inventive concepts herein described. For example, although shown and described as having an end effector having clamping members, it will be recognized that other types of end effectors may be incorporated to achieve other functions. Additionally although control cable 25 is shown attached to housing 2, it will be understood that an additional electrical interface may be included in housing 2 for connection to a separate control cable having connector 26 on one end and an additional identical plug on the other. It is understood, therefore, that the invention is capable of modification and therefore is not to be limited to the precise details set forth. Rather, various modifications may be made in the details within the scope and range of equivalents of the claims without departing from the spirit of the invention.

What is claimed is:

1. An electronic pendant controller for use with an overhead lifting system, comprising:
a housing having at least one electrical control for controlling at least one signal selected from the group consisting of an input signal, an output signal, and combinations thereof between said pendant controller and a control device for said overhead lifting system; and
a first electronic interface for conducting a signal selected from the group consisting of an input signal, an output signal, and combinations thereof between said pendant controller and an end effector attached to said pendant controller.

2. The electronic pendant controller according to claim 1, further comprising a control cable attached to said housing for transmitting and receiving said at least one signal between said pendant controller and said control device.

3. The electronic pendant controller according to claim 2, wherein said control cable is integral with said housing and terminates in a pin-type connector for attachment to said control device.

4. The electronic pendant controller according to claim 1, wherein said housing further comprises an internal microprocessor attached to at least one of said at least one electrical control, said first electronic interface, said control device, and combinations thereof.

5. The electronic pendant controller according to claim 1, wherein at least one of said electrical controls is an analog, bi-directional proportional controller for changing direction and varying speed of said lifting system.

6. The electronic pendant controller according to claim 1, wherein said housing further comprises a second electronic interface for attachment to a load cell.

7. The electronic pendant controller according to claim 6, further comprising a load cell attached to said pendant controller and electrically connected to said second electronic interface.

8. The electronic pendant controller according to claim 6, wherein said second electronic interface is attached to at least one of said at least one electrical control, said first electronic interface, said control device, and combinations thereof.

9. An electronic pendant controller for use with an overhead lifting system, comprising:
a housing having at least one electrical control for controlling a signal selected from the group consisting of an input signal, an output signal, and combinations thereof between said pendant controller and a control device for said overhead lifting system; and
wherein one of said at least one electrical controls is an analog, bi-directional proportional controller for changing direction and varying speed of said lifting system.

10. The electronic pendant controller recited in claim 9, wherein said analog bi-directional controller is a rocker-switch.

11. An overhead hoist system comprising:
a hoist with a control device for controlling said hoist;
a vertically movable end effector attached to said hoist by a lifting line;
an electronic pendant controller having
a housing having at least one electrical control for controlling at least one signal selected from the group consisting of an input signal, an output signal, and combinations thereof between said pendant controller and said control device; and
a first electronic interface for conducting a signal selected from the group consisting of an input signal, an output signal, and combinations thereof between said pendant controller and said end effector.

12. The overhead hoist system according to claim 11, further comprising a control cable attached to said housing for transmitting and receiving said at least one signal between said pendant controller and said control device.

13. The overhead hoist system according to claim 11, further comprising a load cell on said lifting line between said hoist and said end effector, said load cell being electrically connected to said first electronic interface.

14. The overhead hoist system according to claim 11, wherein said housing further comprises a second electronic interface for attachment to a load cell.

15. The overhead hoist system according to claim 14, further comprising a load cell attached to said pendant controller and electrically connected to said second electronic interface.

16. The overhead hoist system according to claim 14, wherein said second electronic interface is attached to at least one of said at least one electrical control, said first electronic interface, said control device, and combinations thereof.

17. The overhead hoist system according to claim 11, wherein said end effector comprises at least one sensor connected to and in electrical communication with said first electronic interface.

18. The overhead hoist system according to claim 11, wherein said end effector comprises at least one servo connected to and in electrical communication with said first electronic interface.

19. An overhead hoist system for use with an overhead lifting system, comprising:
a hoist with a control device for controlling said hoist;
a vertically movable end effector attached to said hoist;
an electronic pendant controller having
a housing having at least one electrical control for controlling a signal selected from the group consisting of an input signal, an output signal, and combinations thereof between said pendant controller and said control device, and
wherein one of said at least one electrical controls is an analog, bi-directional proportional controller for changing direction and varying speed of said hoist.

20. The overhead hoist system recited in claim 19, wherein said analog bi-directional controller is a rocker-switch.
